(19) United States
(12) Patent Application Publication
(10) Pub. No.: US 2023/0153080 A1
(43) Pub. Date: May 18, 2023

(54) USER-CUSTOMIZED WEB-BASED SYSTEM PROGRAM CREATING SYSTEM

(71) Applicants: AC&T SYSTEM CO., LTD, Anyang-si, Gyeonggi-do (KR); HOWOOCAST, INC., Seoul (KR)

(72) Inventors: Tae Sang KWON, Anyang-si, Gyeonggi-do (KR); Seung Woo LEE, Seoul (KR)

(21) Appl. No.: 17/920,476

(22) PCT Filed: Jun. 1, 2021
(86) PCT No.: PCT/KR2021/006824

§ 371 Date: Oct. 21, 2022

(30) Foreign Application Priority Data
Jun. 3, 2020 (KR) 10-2020-0066970

(51) Int. Cl. G06F 8/34; G06F 8/38; G06F 8/35; G06F 21/44; G06F 8/658

(52) U.S. Cl. CPC G06F 8/34; G06F 8/38; G06F 8/35; G06F 21/44; G06F 8/658

(57) ABSTRACT

According to the example of invention implementation, in terms of preparing a web based program, it is possible to develop a user-customized web-based program plotting system where among various multiple components supporting the various basic platforms on the program execution screen implemented by a manufacturer, a user can select a component corresponding to the basic platform of a web based program that is being prepared and link the selected component to the database to be linked in order to enable each area of component display the desired data and also run the component linked to the database to let it automatically switch to a web-based program source code, thus eventually an ordinary user with the lack of knowledge in programming language can easily prepare a program.

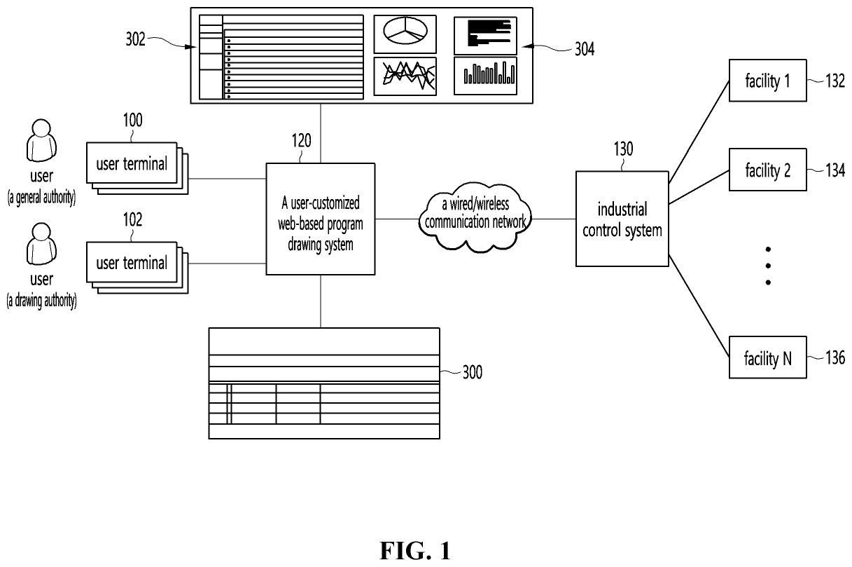

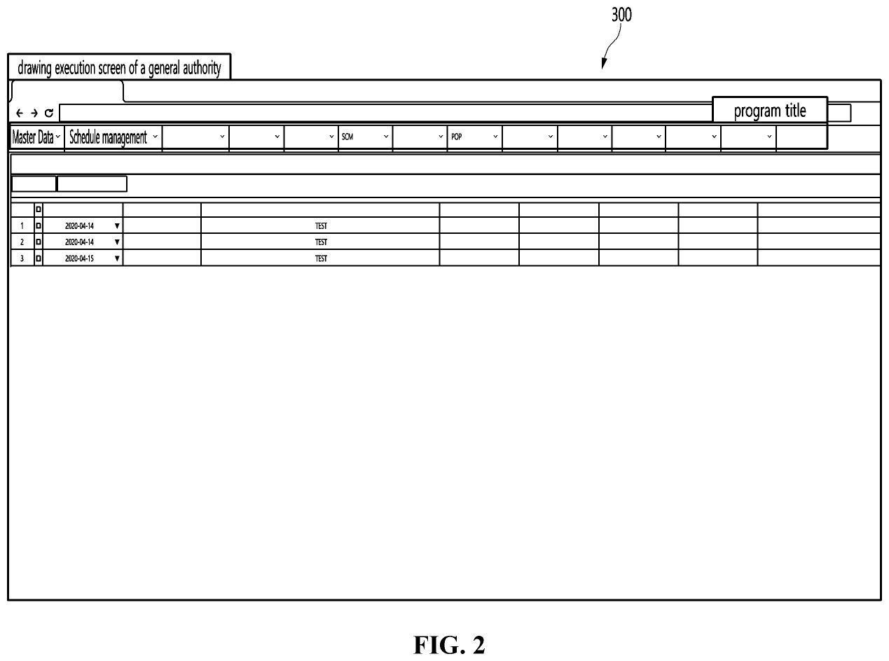

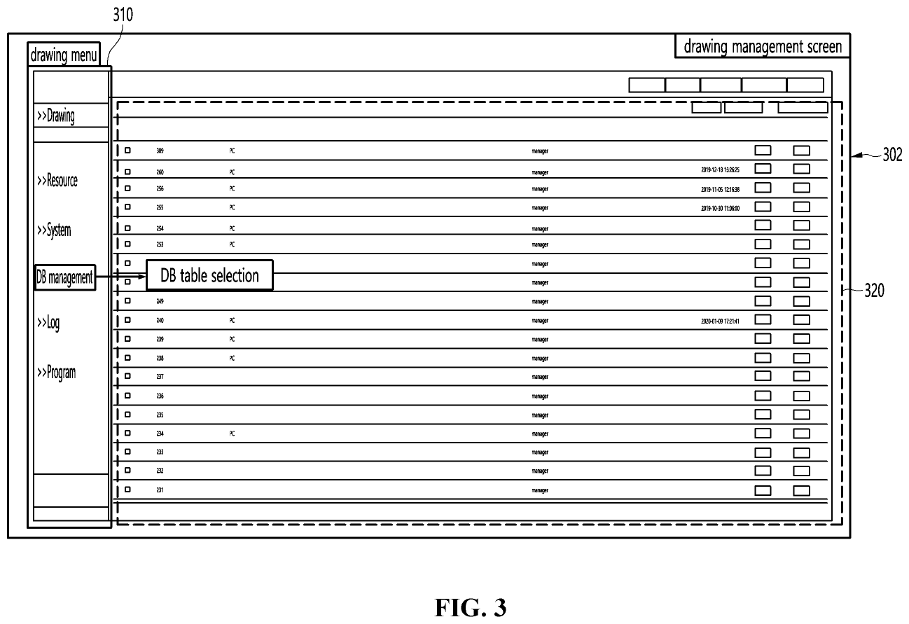

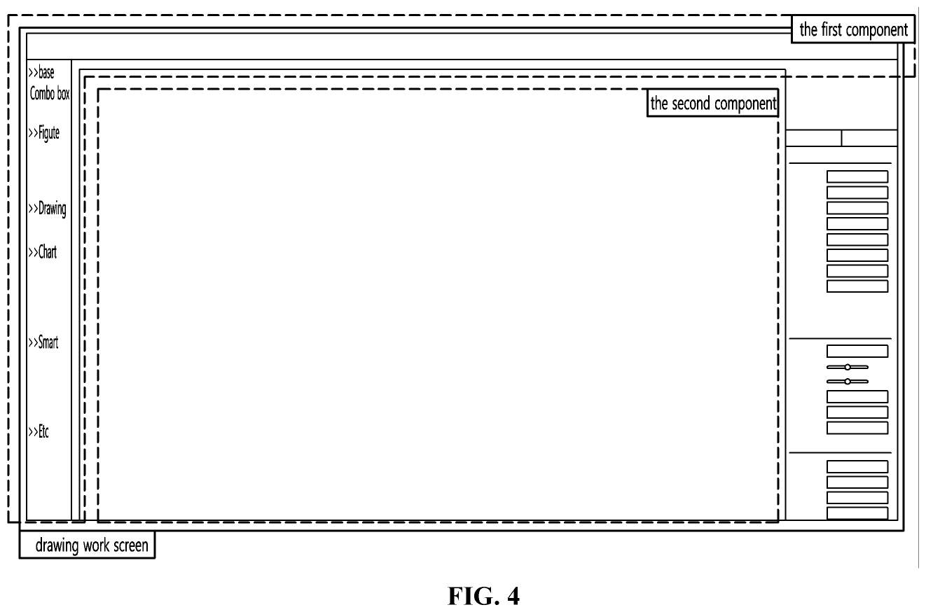

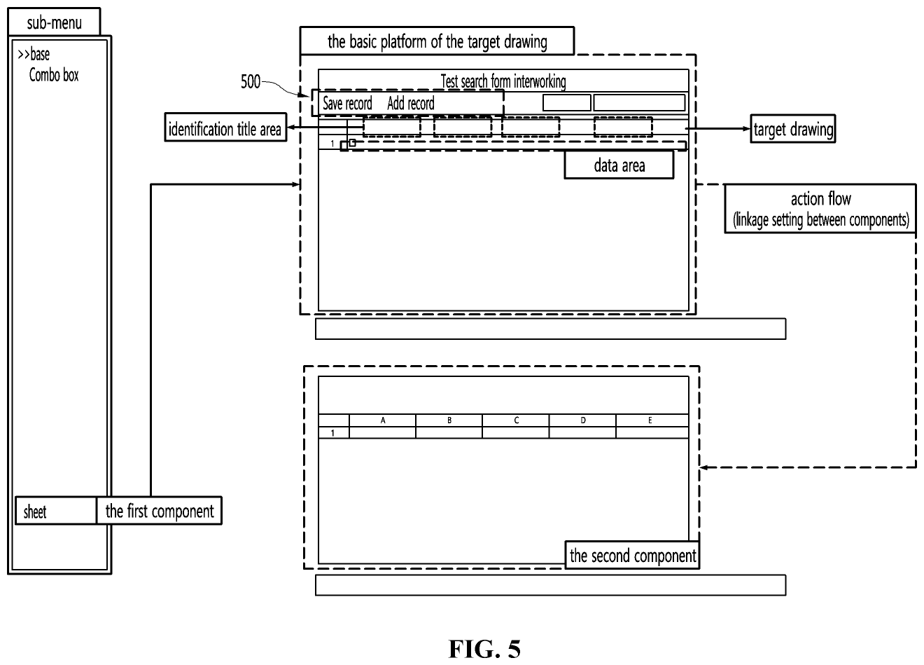

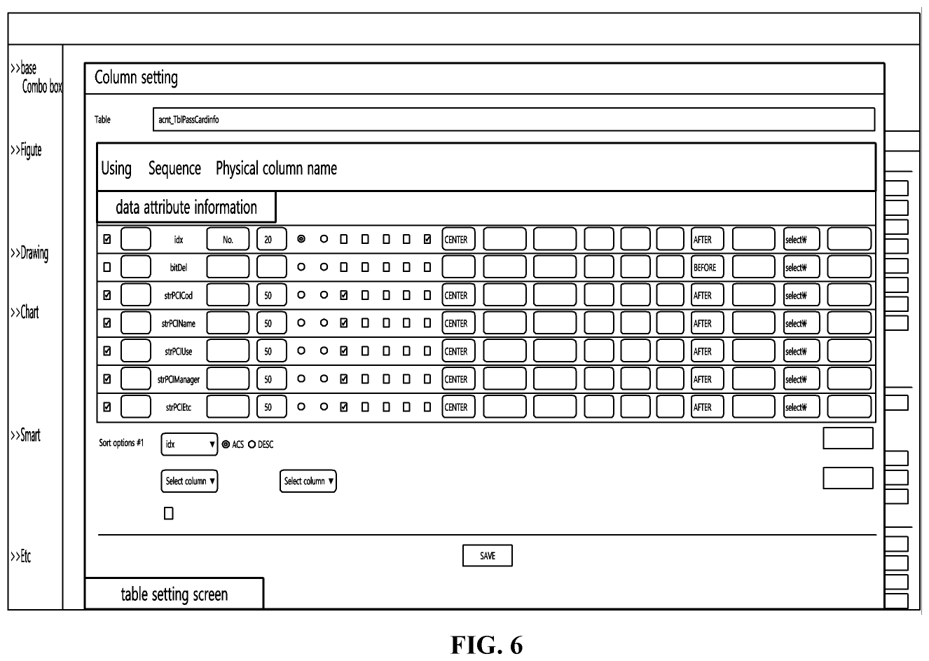

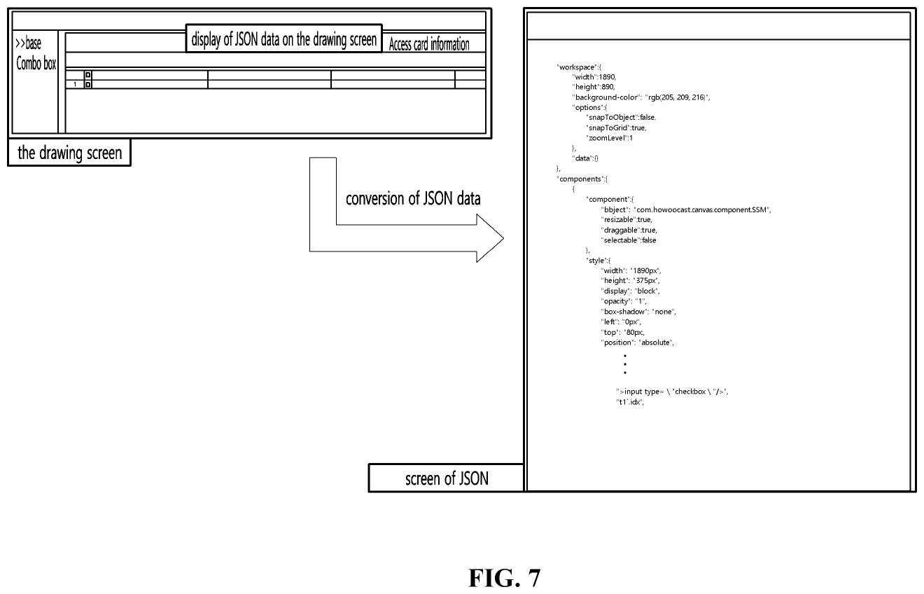

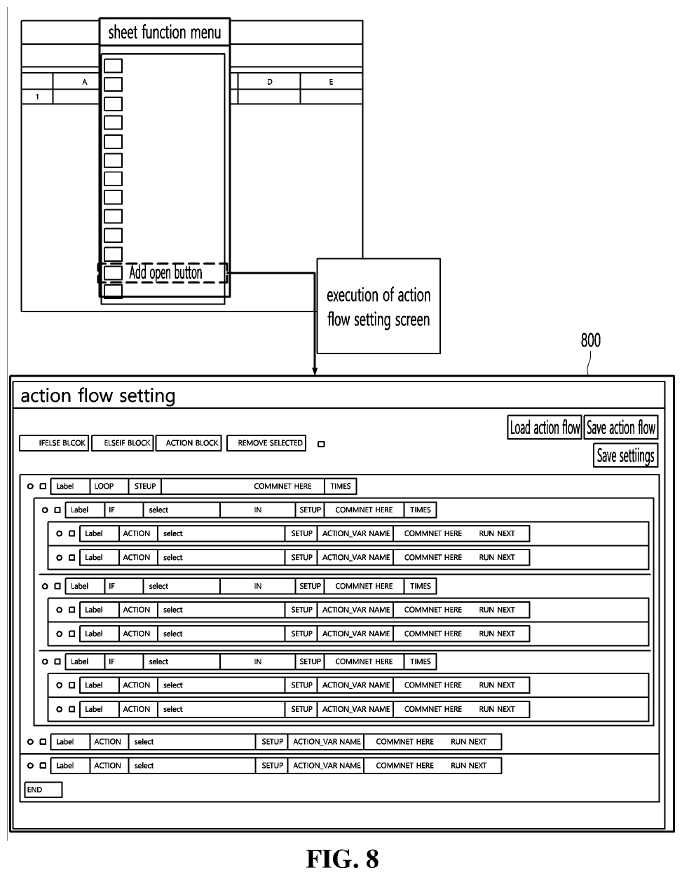

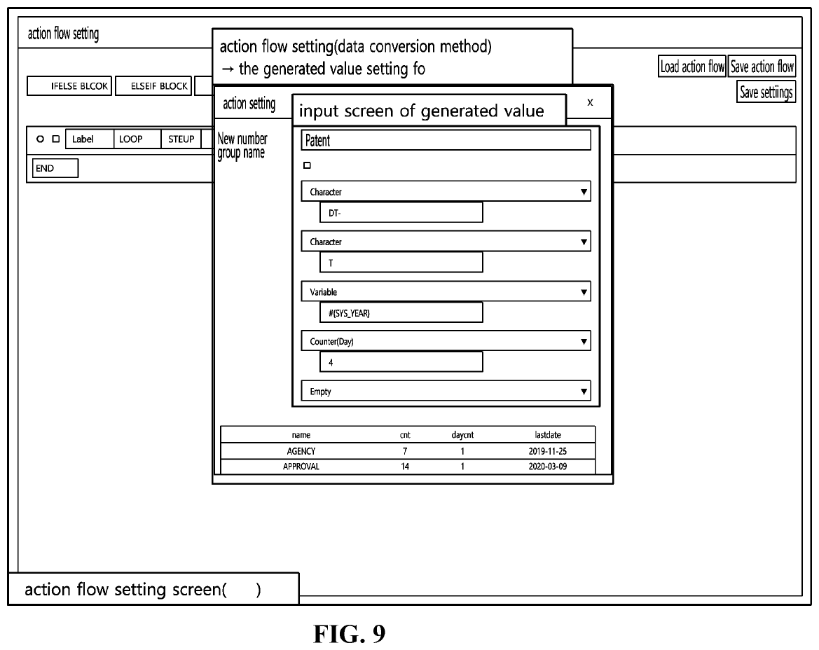

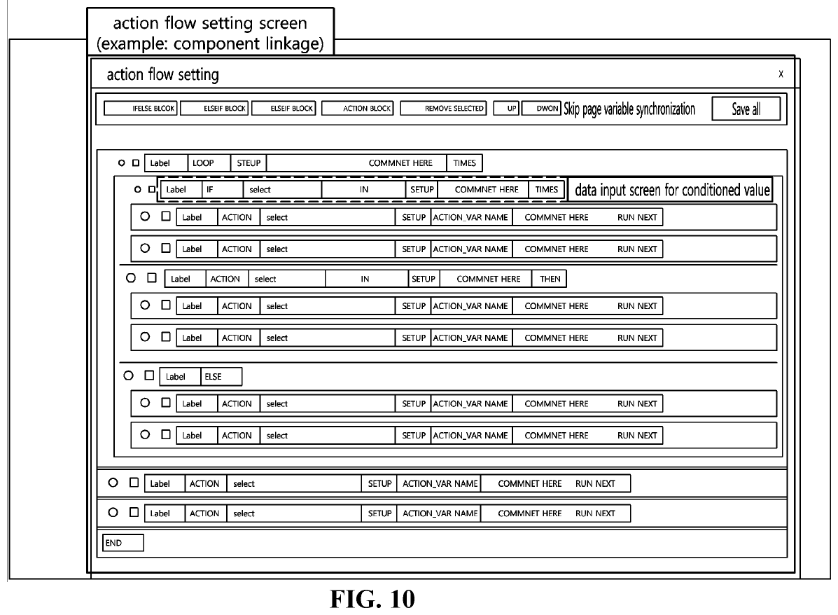

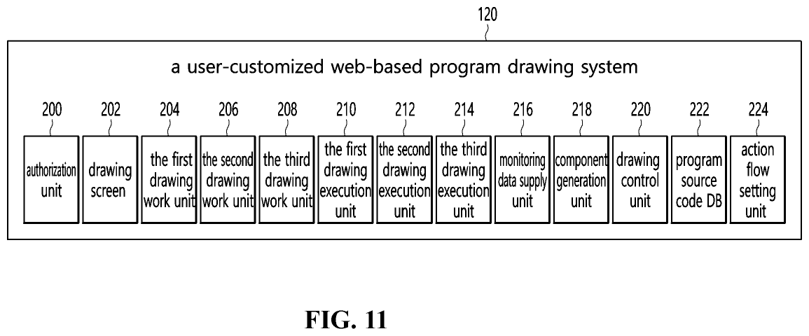

### TECHNICAL AREA

This invention is related to a web based program preparation and especially, in terms of preparing a web based program, it is about a user-customized web-based program plotting system where among various multiple components supporting the various basic platforms on the program execution screen implemented by a manufacturer, a user can select a component corresponding to the basic platform of a web based program that is being prepared and link the selected component to the database to be linked in order to enable each area of component display the desired data and also run the component linked to the database to let it automatically switch to a web-based program source code, thus eventually an ordinary user with the lack of knowledge in programming language can easily prepare a program.

### BACKGROUND TECHNOLOGIES

Generally, when preparing industrial machine control programs or various business management programs, a programmer familiar with the programming language can prepare the program source code that includes the desired operation or functions by using the programming language such as C, Java and so on, and then run the program code on the machine or PC in order to run the program.

However, according to the conventional method, only a user skilled with the programming language can prepare the program and a user who lacks the knowledge in the programming language cannot prepare it, thus even if there is slight change to be made on the user's GUI, a task has to be assigned to the programmer who wrote it initially, thus the procedure is very tedious and it takes relatively long time even for a simple task.

In addition, from the perspectives of a programmer who is assigned the task to modify the program, they would have to write the entire source code again, and thus it is complex and slow in responding to the situation changes, eventually degrading the business efficiency.

### DETAILED DESCRIPTION OF INVENTION

### Technical Challenges

Therefore, the purpose of this invention is to,in terms of preparing a web based program, to develop a a user-customized web-based program plotting system where among various multiple components supporting the various basic platforms on the program execution screen implemented by a manufacturer, a user can select a component corresponding to the basic platform of a web based program that is being prepared and link the selected component to the database to be linked in order to enable each area of component display the desired data and also run the component linked to the database to let it automatically switch to a web-based program source code, thus eventually an ordinary user with the lack of knowledge in programming language can easily prepare a program.

The purpose of this invention is not limited to the above-mentioned ones, but other purposes and advantages of the invention not mentioned here can be easily understood through the below explanations, and they can be more clearly understood through the use of the actual examples of invention implementation. In addition, it is obvious that the purpose and advantages of this invention can be achieved by using the tools shown in the scope of claims and by combining them accordingly.

### Technical Solutions

According to the invention, this user-customized web-based program plotting system may include the following: the authentication unit which is connected to multiple user terminals over wireless or wired networks and which can determine whether a user accessing the above system is a plotting user or general user when one of the multiple user terminals is accessing the system, the plotting screen management unit which can display the plotting management screen with the implemented plotting menu that can use graphic plotting to convert it to the web based programming language when the user is identified as a plotting user and which displays the plotting screen with at least one program title created from plotting when the user is identified as a general user, the 1st plotting unit that displays the plotting screen made of the 1st area equipped with the sub menu related to the program creation tasks and the 2nd area where the plotting works corresponding to the program creation works is done when the program creation work is selected by the plotting user in the above plotting menu, the 2nd plotting unit which detects the selection of the 1st component and displays the basic platform of target plotting corresponding to the above 1st component in the location within the 2nd area as it searches for a new location in the 2nd area as the 1st component is dragged by a user location in the 2nd area when any one of the 1st component among the multiple components available for plotting in the above sub menu is selected, the 3rd plotting unit which displays the 1st DB table setting screen and receives inputs of attributes about data to be added to each identification name area and the actual identification name to be displayed in each identification name area of the first component on the above table setting screen and registers the above 1st DB table when a user selects to create the 1st DB table to be linked to the above 1st component in the plotting menu and which displays the identification name registered in the 1st DB table in each identification name area of the 1st component by mapping them one by one upon requests for a connection between the 1st components and finally the plotting control unit which displays the above target program execution screen in correspondence to the shape of the above 1st component when a user inputs to run the above target plotting program where the above 1st DB table is connected to the 1st component and which converts the target plotting into the primary source code in pre-set web-based programing language upon requests for completing the program creation works.

In addition, the above system may include the action flow setting unit that displays proper things in correspondence to the key inputs or their combinations with the action flow menu to set the data linkage between the above 1st and 2nd components or data conversion inputted in each identification name area of the above 1st component and displays the above action flow setting screen and receives inputs about the action flow setting information for the linkage or data conversion in the above action flow setting screen and registers the action flow setting information about each identification name of the above target plotting when a user selects a menu item linked to the action flow setting in the above action flow menu.

In addition, the above action flow setting unit can provide at least one creation data input window that allows setting of the creation value selected by the plotting among data added to the identification name area in the action flow setting screen related to the above data conversion method and also save the creation inputs values received from the plotting user in each creation data input window

In addition, the above action flow setting unit can provide at least one condition value data input window where a user can set the linkage between data in one of the identification name area among all identification name areas on the above 1st component or every data in the above identification name area and data in the identification name area corresponding to the above 2nd component in the action flow setting screen under the above linkage relations and save the condition values inputted from the plotting user in each conditional data input window.

In addition, the above plotting controller can, once the target plotting results are converted into the 1st program source code, register the above 1st program source code as the file name selected by the above plotting user and link it to the program title of the above target plotting and save it in the program source code DB and receive the information about the target location to display on the above plotting execution screen depending on whether the above target plotting is exposed to the above plotting execution screen and save the results in conjunction with the about program title.

In addition, the above plotting control unit can extract the above target location information designated to expose the above target plotting to the above plotting execution screen and thus provide it for the above plotting screen management unit when the above target plotting is set to enable exposures to the above plotting execution screen and the above plotting screen management unit can display the program title of the above target plotting in the area corresponding to the above target location information on the above plotting execution screen and thus activate the selection of the above target plotting.

In addition, it can further include the 1st plotting execution unit that displays the above target plotting execution screen by running the above 1st program source code saved in linkage to the above target plotting when the above target plotting program title is selected, the 2nd plotting execution unit that displays the data input window for the above identification name area and uses the above data input window to receive data corresponding to each identification name area of the above target plotting to display the above data in the above target plotting execution screen when the above data input menu is selected after activating the data input menu on the above target plotting execution screen, and the 3rd plotting execution unit which displays the above 2nd component and enables automatic displaying of the data linked to the 1st or 2nd data in each identification name area on the above 2nd component based on the above condition value when the above linked action flow setting area is selected on the above target plotting execution screen and the above plotting control unit can renew the 1st program source code of the above target plotting to the 2nd program source code with the above added, changed, or detected data and save it accordingly when the data is added, changed, renewed, or deleted in each identification name area on the above 1st and 2nd component according to operation in the above 1st, 2nd and 3rd plotting execution unit.

In addition, the above 2nd plotting execution unit can enable automatic displaying of the above creation values in an area corresponding to the identification name area on the above data input window where the above data conversion based action flow is set for each identification name area.

In addition, the above system further includes the monitoring data supply unit which is responsible for consistently supplying the specific facility's monitoring data corresponding to each identification name area of the above target plotting and which is connected via wireless or wired networks to the industrial control system which is connected to various machine or electronic facilities installed in the industrial sites to collect the facility operation status related monitoring data and the above 2nd plotting execution unit can use the above monitoring data supply unit to receive the facility monitoring data and display the above monitoring data on each identification name area on the above target plotting execution screen in case that the above target plotting is used to monitor the operational status of each facility.

In addition, the above plotting control unit can display the source code change setting screen that displays the filename of the program source of of the entire plotting registered by the above plotting user and provide the file selection prompt window to select each program source code on the above source code change setting screen when there is a request for changing the program source code in conjunction to the program title of the above target plotting and sets the linkage to the program title of the above target plotting from the new program source code corresponding to the selected filename when a single filename is selected in the above file selection window, and the above 1st plotting execution unit can run the new program source code to display the above target plotting execution screen when the program title of the above target plotting is selected on the above plotting execution screen after the above program source code is changed.

In addition, the above 3rd plotting task unit can display a window to select whether to expose multiple identification names registered in the 1st DB table to the above 1st component and display only the identification names that are allowed to be exposed in the above exposure selection window to the above 1st DB table in the order of registration by mapping them to each identification name area on the above 1st component.

In addition, the above 2nd plotting task unit can activate the size adjustment function of the above basic platform and thus change the size of the above basic platform in correspondence to the dragging inputs of size change from the above plotting user when the basic platform of the above target plotting is displayed in the above 2nd area.

In addition, the above plotting screen management unit can, once the above user terminal is authenticated as one belonging to a general user, enable displaying of the above plotting execution screen with at least one program title registered by the above plotting user in the above user terminal's display unit.

In addition, the above system further includes the component generation unit which is connected to the above system over wireless or wired network, and which can register the components created newly from the plotting system manufacturer and the above plotting control unit can use the above component generation unit to include the above new components in the above plotting menu to renew to above plotting menu when new components are updated through the above component generation unit.

In addition, the basic platform of the above target plotting can be generated in any one of the following forms: combo boxes, buttons, text, figures, images, charts, calendars, fields, form or sheets.

Besides, the above web-based programming language might be JSON.

### Effects of Invention

According to the example of invention implementation, in terms of preparing a web based program, it is possible to develop a user-customized web-based program plotting system where among various multiple components supporting the various basic platforms on the program execution screen implemented by a manufacturer, a user can select a component corresponding to the basic platform of a web based program that is being prepared and link the selected component to the database to be linked in order to enable each area of component display the desired data and also run the component linked to the database to let it automatically switch to a web-based program source code, thus eventually an ordinary user with the lack of knowledge in programming language can easily prepare a program.

In addition, as a user can easily prepare, modify, add or update the program, it is possible to greatly reduce the program preparation and management costs and it can also facilitate repair and maintenance.

As well as the above discussed effects, more specific effects of the invention are provided along with the specific explanation of items necessary for implementing the invention.

### SIMPLE EXPLANATION OF DIAGRAMS

Diagram 1 is a network configuration diagram for the user-customized web-based program plotting system according to the example of invention implementation.

Diagram 2 is an exemplary diagram of the general user's plotting execution screen according to an example of invention implementation.

Diagram 3 is an exemplary diagram of the plotting user's plotting management screen according to an example of invention implementation.

Diagram 4 is an exemplary diagram of the plotting user's plotting task screen according to an example of invention implementation.

Diagram 5 is an exemplary diagram of the basic platform of target plotting according to an example of invention implementation.

Diagram 6 is an exemplary diagram of the DB table setting screen according to an example of invention implementation.

Diagram 7 is an exemplary diagram of the source code for the web-based program language according to an example of invention implementation.

Diagram 8 is an exemplary diagram of the action flow menu screen according to an example of invention implementation.

Diagram 9 is an exemplary diagram of the action flow setting screen related to data conversion methods in the according to an example of invention implementation.

Diagram 10 is an exemplary diagram of the action flow setting screen related to component data linkage relations according to an example of invention implementation.

Diagram 11 is a detailed block diagram for the user-customized web-based program plotting system according to the example of invention implementation.

### BEST FORM OF INVENTION IMPLEMENTATIONS

In the following, the operational principles of the invention will be explained in detail by referring to diagrams attached. Hereinafter, when explaining the invention, if it is deemed that more specific explanations about the noticed function or configuration can lead to confusions in understanding the essence of the invention, they will be omitted. And the terms that are described later are defined based on the considerations of the function of the invention, thus it can vary depending on use or operator's intention or customs and so on. Therefore, the definition should be made based on the overall content of the specification.

Diagram 1 is a network configuration diagram for the user-customized web-based program plotting system according to the example of invention implementation.

Hereinafter, by referring to Diagram 1, more detailed explanations will be provided on operation in each component of the network configuration.

First, the term, user terminal (100, 102) may refer to a user's wireless or wired terminal that is used to perform program plotting by accessing to the user-customized web-based program plotting system (12) that is connected to wireless or wired networks including internet.

This kind of user terminal (100, 102) might be a communication device such as PC equipped with web browsers, mobile communication terminal, PDA(personal digital assistant), TV with the internet access but not limited to them.

In other words, a user can use the above user terminal to register as a member at the web-based program plotting system (12) and prepare web-based programs using plotting in the plotting management screen with plotting menus that enable graphic based program plotting or run various programs on the plotting execution screen that displays the plotted program title.

According to an example of invention implementation, the web-based program plotting system (120) can connect to a user terminal (100, 102) or industrial control system (130) through the wireless and wired network such as internet. In addition, it may refer to a system providing plotting service that helps user to easily make a program even in case that they are unable to program it unless with a web-base program language, by proving the automatic conversion function for web-based programming language program source code through graphic based plotting for a user accessing through a user terminal.

Now, regarding the above plotting service, it can additionally include plotting services for various management programs related to the production and management in terms of entrepreneurial activities such as management control inventory management, service management, attendance management and so on as well as plotting service for monitoring programs that helps them to check the operational status of facility based on the monitoring data inputted from various facilities (132, 134, 136) such as various machinery, or electronic facilities and so on.

First, taking a glance at the plotting service for various management programs, the web-based program plotting system (120) is connected to multiple user terminals over wireless and wired networks, if one of user terminal among multiple user terminals access the web-based program plotting system (120), it will authenticate whether this user accessing through the user terminal is a legitimate user. Here, a legitimate user refers to an employee of the company included in the web-based program plotting system and so on, and a legitimate user can be granted authenticated information such as an ID or password and so on.

Therefore, when a user is accessing the web-based program plotting system through their user terminal (1000), for example, they will have to enter authentication information such as ID or password granted from the member registration process, and the web-based program plotting system (12) will determine whether a user accessing through the user terminal is a legitimate user registered in the web-based program plotting system based on the received authentication information.

So, as long as a user is authenticated as a legitimate user, the web-based program plotting system (12) can allow a user to run the program prepared through plotting in the web-based program plotting system or use the plotting service provided from the web-based program plotting system to prepare a web-based program even if they lack professional knowledge in web-based program language.

Now, in the process of member registration at the web-based program plotting system, a user can be registered as a plotting user or general user depending on the authority for program plotting.

For example, if an authenticated user is a general user, the web-based program plotting system (12), as shown in Diagram 2 User Terminal Device, can display the plotting execution screen (300) where the title of program registered and prepared by the plotting user is displayed, and also run the program by running the program source code saved in linkage to the program title when a specific program title is selected by a user.

In addition, for example, when an authenticated user is a plotting user, the web-based program plotting system (12) can display the plotting management screen (302) with plotting menus that helps a user to use their terminal for graphic based plotting to convert it into the program source code of the web-based programing language, so that a user registered as a plotting authority owner can use the graphic based plotting to more easily prepare various programs without using the programming language.

Hereinafter, detailed explanations will be provided on operation to enable program plotting on by displaying the plotting management screen (302) on the web-based program plotting system *12) and receiving requests of plotting users on the plotting management screen.

First of all, when a plotting user is logged in, the web-based program plotting system (120) displays the plotting management screen (300) as shown in Diagram 3 on the user terminal.

The above plotting management screen, as shown in Diagram 3, can be made of the menu area (310) that displays various plotting menus related to the plotting and the content area (320) that displays the details of each menu selected in the menu area.

In Diagram 3, the menus area as an example of implementation,

Hierarchy list of pre-text

| | |
|---|---|
| 200: Authentication unit | 202: Plotting screen management unit |
| 204: 1st plotting task unit | 206: 2nd plotting task unit |
| 208: 3rd plotting task unit | 210: 1st plotting execution unit |
| 212: 2nd plotting execution unit | 214: 3rd plotting execution unit |
| 216: Monitoring data supply unit | 218: Component generation unit |
| 220: Plotting control unit | 222: Program source code DB |
| 224: Action flow setting unit | |

1. A user-customized web-based program plotting system comprising:
an authentication unit which is connected to multiple user terminals over wireless or wired networks and which can determine whether a user accessing the above system is a plotting user or general user when one of the multiple user terminals is accessing the system the plotting screen management unit which can display the plotting management screen with the implemented plotting menu that can use graphic plotting to convert it to the web-based programming language when the user is identified as a plotting user and which displays the plotting screen with at least one program title created from plotting when the user is identified as a general user,
a 1st plotting unit that displays the plotting screen made of the 1st area equipped with the sub menu related to the program creation tasks and the 2nd area where the plotting works corresponding to the program creation works is done when the program creation work is selected by the plotting user in the above plotting menu,
a second plotting unit which detects the selection of the 1st component and displays the basic platform of target plotting corresponding to the above 1st component in the location within the 2nd area as it searches for a new location in the 2nd area as the 1st component is dragged by a user location in the 2nd area when any one of the 1st component among the multiple components available for plotting in the above sub menu is selected,
a 3rd plotting unit which displays the 1st DB table setting screen and receives inputs of attributes about data to be added to each identification name area and the actual identification name to be displayed in each identification name area of the first component on the above table setting screen and registers the above 1st DB table when a user selects to create the 1st DB table to be linked to the above 1st component in the plotting menu and which displays the identification name registered in the 1st DB table in each identification name area of the 1st component by mapping them one by one upon requests for a connection between the 1st components,
a plotting control unit which displays the above target program execution screen in correspondence to the shape of the above 1st component when a user inputs to run the above target plotting program where the above 1st DB table is connected to the 1st component and which converts the target plotting into the primary source code in pre-set web-based programing language upon requests for completing the program creation works.

2. The system of claim 1, further comprising an action flow setting unit that displays proper things in correspondence to the key inputs or their combinations with the action flow menu to set the data linkage between the above 1st and 2nd components or data conversion inputted in each identification name area of the above 1st component and displays the above action flow setting screen and receives inputs about the action flow setting information for the linkage or data conversion in the above action flow setting screen and registers the action flow setting information about each identification name of the above target plotting when a user selects a menu item linked to the action flow setting in the above action flow menu.

3. The system of claim 2, wherein the above action flow setting unit in the user-customized web-based program plotting system can provide at least one creation data input window that allows setting of the creation value selected by the plotting among data added to the identification name area in the action flow setting screen related to the above data conversion method and also save the creation inputs values received from the plotting user in each creation data input window.

4. The system of claim 3, wherein the above action flow setting unit in the user-customized web-based program plotting system can provide at least one condition value data input window where a user can set the linkage between data in one of the identification name area among all identification name areas on the above 1st component or every data in the above identification name area and data in the identification name area corresponding to the above 2nd component in the action flow setting screen under the above linkage relations and save the condition values inputted from the plotting user in each conditional data input window.

5. The system of claim 4, wherein the above plotting controller in the user-customized web-based program plotting diagram, once the target plotting results are converted into the 1st program source code, register the above 1st program source code as the file name selected by the above plotting user and link it to the program title of the above target plotting and save it in the program source code DB and receive the information about the target location to display on the above plotting execution screen depending on whether the above target plotting is exposed to the above plotting execution screen and save the results in conjunction with the about program receive the information about the target location to display on the above plotting execution screen depending on whether the above target plotting is exposed to the above plotting execution screen and save the results in conjunction with the about program title.

6. The system of claim 5, wherein the above plotting controller in the user-customized web-based program plotting diagram can extract the above target location information designated to expose the above target plotting to the above plotting execution screen and thus provide it for the above plotting screen management unit when the above target plotting is set to enable exposures to the above plotting execution screen,
and the above plotting screen management unit
can display the program title of the above target plotting in the area corresponding to the above target location information on the above plotting execution screen and thus activate the selection of the above target plotting.

7. The system of claim 6, further comprising a 1st plotting execution unit that displays the above target plotting execution screen by running the above 1st program source code saved in linkage to the above target plotting when the above target plotting program title is selected,
a 2nd plotting execution unit that displays the data input window for the above identification name area and uses the above data input window to receive data corresponding to each identification name area of the above target plotting to display the above data in the above target plotting execution screen when the above data input menu is selected after activating the data input menu on the above target plotting execution screen,
a 3rd plotting execution unit which displays the above 2nd component and enables automatic displaying of the data linked to the 1st or 2nd data in each identification name area on the above 2nd component based on the above condition value when the above linked action flow setting area is selected on the above target plotting execution screen
the above plotting controller in the user-customized web-based program plotting diagram,
can renew the 1st program source code of the above target plotting to the 2nd program source code with the above added, changed, or deleted data and save it accordingly when the data is added, changed, renewed, or deleted in each identification name area on the above 1st and 2nd component according to operation in the above 1st, 2nd and 3rd plotting execution unit.

8. The system of claim 7, wherein the 2nd plotting execution unit in the user-customized web-based program plotting system can enable automatic displaying of the above creation values in an area corresponding to the identification name area on the above data input window where the above data conversion based action flow is set for each identification name area.

9. The system of claim 8, further comprising a monitoring data supply unit which is responsible for consistently supplying the specific facility's monitoring data corresponding to each identification name area of the above target plotting and which is connected via wireless or wired networks to the industrial control system which is connected to various machine or electronic facilities installed in the industrial sites to collect the facility operation status related monitoring data and the above 2nd plotting execution unit can use the above monitoring data supply unit to receive the facility monitoring data and display the above monitoring data on each identification name area on the above target plotting execution screen in case that the above target plotting is used to monitor the operational status of each facility.
the above 2nd plotting execution unit in the user-customized web-based program plotting system can use the above monitoring data supply unit to receive the facility monitoring data and display the above monitoring data on each identification name area on the above target plotting execution screen in case that the above target plotting is used to monitor the operational status of each facility.

10. The system of claim 9, the plotting controller in the user-customized web-based program plotting diagram can display the source code change setting screen that displays the filename of the program source of the entire plotting registered by the above plotting user and provide the file selection prompt window to select each program source code on the above source code change setting screen when there is a request for changing the program source code in conjunction to the program title of the above target plotting
and sets the linkage to the program title of the above target plotting from the new program source code corresponding to the selected filename when a single filename is selected in the above file selection window,
and the above 1st plotting execution unit in the user-customized web-based program plotting diagram
can run the new program source code to display the above target plotting execution screen when the program title of the above target plotting is selected on the above plotting execution screen after the above program source code is changed.

11. The system of claim 1, wherein the 3rd plotting task unit in the user-customized web-based program plotting system can display a window to select whether to expose multiple identification names registered in the 1st DB table to the above 1st component and display only the identification names that are allowed to be exposed in the above exposure selection window to the above 1st DB table in the order of registration
and display only the identification names that are allowed to be exposed in the above exposure selection window to the above 1st DB table in the order of registration by mapping them to each identification name area on the above 1st component.

12. The system of claim 1, wherein the 2nd plotting task unit in the user-customized web-based program plotting system can activate the size adjustment function of the above basic platform and thus change the size of the above basic platform in correspondence to the dragging inputs of size change from the above plotting user when the basic platform of the above target plotting is displayed in the above 2nd area.

13. The system of claim 1, wherein the plotting screen management unit in the user-customized web-based program plotting system can enable displaying of the above plotting execution screen with at least one program title registered by the above plotting user in the above user terminal's display unit, once the above user terminal is authenticated as one belonging to a general user.

14. The system of claim 1, further comprising a component generation unit which is connected to the above system over wireless or wired network, and which can register the components created newly from the plotting system manufacturer, wherein the plotting controller in the user-customized web-based program plotting diagram can use the above component generation unit to include the above new components in the above plotting menu to renew to above plotting menu when new components are updated through the above component generation unit.

15. The system of claim 1, wherein the basic platform of the above target plotting in the user-customized web-based program plotting system can be generated in any one of the following forms: combo boxes, buttons, text, figures, images, charts, calendars, fields, form or sheets.

16. The system of claim 1, wherein the web-based programming language is a JSON user-customized web-based program plotting program.
